(19) United States
(12) Patent Application Publication
(10) Pub. No.: US 2020/0073973 A1
(43) Pub. Date: Mar. 5, 2020

(54) DIGITALIZING SYSTEM AND METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XUE-QIN ZHANG, Shenzhen (CN)

(21) Appl. No.: 16/195,250

(22) Filed: Nov. 19, 2018

(30) Foreign Application Priority Data
Sep. 3, 2018 (CN) 201811020065.7

(51) Int. Cl. G06F 17/30

(52) U.S. Cl. CPC G06F 17/30312; H04L 67/10

(57) ABSTRACT

An electronic device includes a processor and a memory. The processor inputs device information of a number of devices to the electronic device, assigns a serial number to each device, stores the serial number and the device information of each device, and sends the serial number and the device information of each device to a server. The device information includes at least component information, control process information, operation data, failure warning data, and test data.

### FIELD

The subject matter herein generally relates to electronic devices, and more particularly to a method of digitalizing device information of a plurality of devices.

### BACKGROUND

Automated equipment generally requires a record of the equipment for maintenance and management purposes. Information of the equipment may not be complete, which affects the ability to manage and maintain the equipment.

### BRIEF DESCRIPTION OF THE DRAWINGS

Implementations of the present disclosure will now be described, by way of embodiment, with reference to the attached figures.

FIG. 1 is a block diagram of an embodiment of an electronic device implementing a digitalizing system.

FIG. 2 is a flowchart of a method of digitalizing device information.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

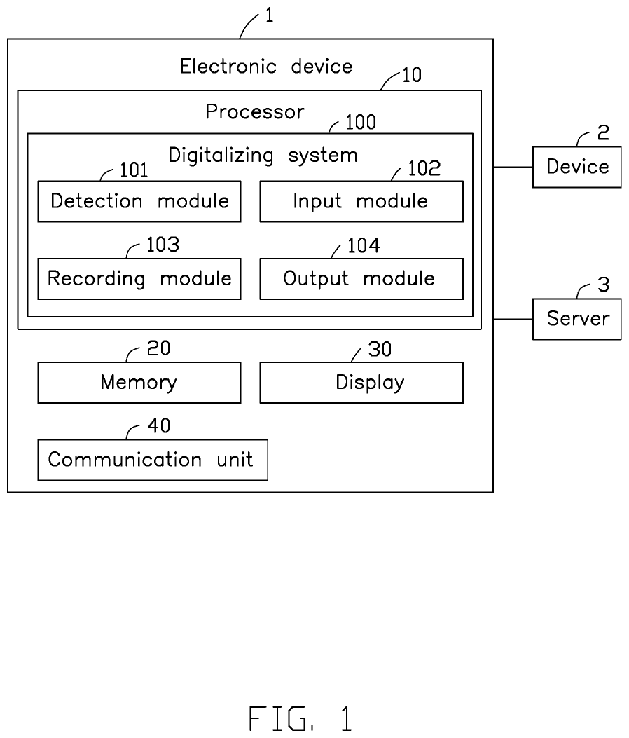

FIG. 1 shows an embodiment of an electronic device 1. The electronic device 1 implements a digitalizing system adapted for consolidating device information of one or more devices 2. In one embodiment, the electronic device 1 is a personal computer or a server.

The electronic device 1 includes, but is not limited to, a processor 10, a memory 20, a display 30, and a communication unit 40. In one embodiment, the memory 20 is a read-only memory or a random-access memory. The display 30 is a liquid crystal display for displaying the device information of the device 2. The communication unit 40 is a wired or wireless communication device, such as a router, for establishing communication with the device 2.

The digitalizing system 100 includes a plurality of modules, such as a detection module 101, an input module 102, a recording module 103, and an output module 104. The modules 101-104 can include one or more software programs in the form of computerized codes stored in the memory 20. The computerized codes can include instructions executed by the processor 10 to provide functions for the modules 101-104.

The detection module 101 detects in real time whether a predetermined condition of inputting device information is activated. In one embodiment, the device information includes at least component information, control process information, operation data, failure warning data, and test data. The predetermined condition is when an input device is used to input new device information to the electronic device 1. In other words, the detection module 101 detects in real time whether new device information is input to the electronic device 1 by an input device.

The input module 102 inputs the device information of each of the devices 2 to the electronic device 1.

Specifically, the input module 102 responds when an input device is used to input new device information to the electronic device 1. The device information of every device 2 may be manually input to the electronic device 1 through an input device of the device 1. In one embodiment, the input device of the electronic device 1 may be a keyboard, a scanner gun, or a camera.

In another embodiment, each of the devices 2 automatically sends a record of the device information to the electronic device 1 through the communication unit 40.

The component information includes at least a model number, a manufacturer, a manufacture date, an installation date, a size, a material, a function, an installation location, a control port, and a control command.

The control process information includes at least control steps of the device 2, control commands of control nodes, control parameters, a logic relationship between control parameters, and a logic relationship between the control commands.

The operation data includes at least a temperature, a humidity, an operation current, an operation voltage, an operation speed of each operation, an acceleration, an operation height, an operation location, and an angle and a direction of each component during operation of the device 2.

The failure warning data includes at least a failure warning serial number, a failure type, and a failure reason;

The test data includes test data of device processing, generating, operating, and testing processes.

In one embodiment, the predetermined condition of inputting the component information includes replacing a component, repairing a component, assembling a component, scanning a serial code of a component, and 3D scanning an image of a component. The serial number is a bar code or QR code. For example, when a component is replaced, repaired, or assembled, the input device can be used to input the component information. The detection module 101 compares the component information input by the input device to original component information of the same component to determine whether the component information is updated. When the component information is updated, the input module 102 stores the updated component information to the memory 20. When the input device is a scanner gun to obtain a serial number of the component, the detection module 101 compares the serial number to the original component information of the same component to determined whether the component information is updated. When the component information is updated, the input module 102 stores the updated component information to the memory 20. When the input device is a camera to capture a 3D image of the component, the detection module 101 compares the 3D image to the original component information to determine whether the component information is updated. When the component information is updated, the input module 102 stores the updated component information to the memory 20.

In one embodiment, a communication method between each of the devices 2 and the electronic device 1 includes at least an industrial communication protocol (Mouled Bus, RS232, RS485), a controller area network, and an inter-integrated circuit. The control process information, operation data, failure warning data, and test data of the plurality of devices 2 are sent to the electronic device 1 according to at least one of the above communication methods.

The recording module 103 assigns a serial number to each of the devices 2 and stores the serial number and the device information of every device 2 and links the serial number and the device information together. In one embodiment, the serial number and the device information are stored in the memory 20.

In one embodiment, a format of the serial number is a country code of manufacture+field of use+device function+manufacturer+manufacture serial number. For example, the serial number of the device 2 may be China+industrial manufacture+visual inspection+Company name”+201808250001. The country code of manufacture is the country where the device 2 was manufactured. The field of use includes at least industrial manufacture, agricultural production, medical device, and power equipment. The country code of manufacture, field of use, device function, manufacturer, and manufacture serial number are input by the user through the input device, such as a keyboard, to the electronic device 1.

In another embodiment, the recording module 103 assigns a predetermined letter, number, or an alphanumeric combination to every serial number. For example, CN represents China, US represents United States, a first letter of the field of use represents the field of use, a first letter of the device function represents the device function, and a code represents the manufacturer. Thus, the serial number China+industrial manufacture+visual inspection+Company name”+201808250001 may be written as CN-IM-VI-FC-201808250001. CN represents China, I represents industrial manufacture, VI represents visual inspection, FC represents the name of the manufacturer, and 201808250001 is a serial number of manufacture.

The output module 104 sends the device information and serial number of each of the devices 2 to a server 3 in response to a user operation.

In one embodiment, the server 3 is an Internet-of-things cloud platform server or an Internet cloud platform server. The electronic device 1 communicates with the server 3 through the communication unit 40. In order to provide public access of information, the device 2 is an unclassified device, and the device information can be manually uploaded to the server 3. Thus, another terminal can obtain the device information of the plurality of devices 2 from the server 3, thereby reducing management costs and improving management efficiency of the devices 2.

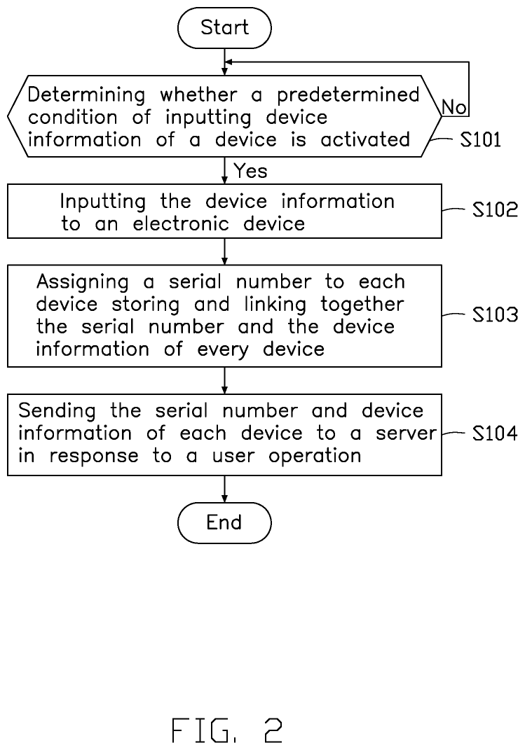

FIG. 2 illustrates a flowchart of an embodiment implemented in an electronic device 1 of digitalizing device information of a plurality of devices 2. There are a variety of ways to carry out the method. The method described below can be carried out using the configurations illustrated in FIG. 1, for example, and various elements of these figures are referenced in explaining the embodiment. Each block shown in FIG. 2 represents one or more processes, methods, or subroutines carried out in the example method. Furthermore, the order of the blocks can be changed. Additional blocks can be added or fewer blocks can be utilized, without departing from this disclosure. The embodiment can begin at block S101.

At block S101, whether a predetermined condition of inputting device information is activated is determined in real time. In one embodiment, the device information includes at least component information, control process information, operation data, failure warning data, and test data. The predetermined condition is when an input device is used to input new device information to the electronic device 1. When the predetermined condition is activated, block S102 is implemented. When the predetermined condition is not activated, block S101 is repeated.

At block S102, the device information of the device 2 is input to the electronic device 1. In one embodiment, the device information is input to the electronic device 1 in response to the device information being input through an input device to the electronic device 1.

At block S103, a serial number is assigned to each of the devices 2 and the serial number and the device information of every device 2 are stored and linked together. In one embodiment, the serial number and the device information are stored in the memory 20.

At block S104, the serial number and device information of each of the devices 2 is sent to the server 3 in response to a user operation. In one embodiment, the server 3 is an Internet-of-things cloud platform server or an Internet cloud platform server.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device comprising:
a processor; and
a memory storing a plurality of instructions of a digitalizing system, which when executed by the processor, cause the processor to:
input device information of a plurality of devices to the electronic device, the device information comprising at least component information, control process information, operation data, failure warning data, and test data;
assign a serial number to each of the plurality of devices and store the serial number and the device information of each of the plurality of devices; and
send the serial number and the device information of each of the plurality of devices to a server.

2. The electronic device of claim 1, wherein:
the component information comprises at least a model number, a manufacturer, a manufacture date, an installation date, a size, a material, a function, an installation location, a control port, and a control command;
the control process information comprises at least control steps of the device, control commands of control nodes, control parameters, a logic relationship between control parameters, and a logic relationship between the control commands;
the operation data comprises at least a temperature, a humidity, an operation current, an operation voltage, an operation speed of each operation, an acceleration, an operation height, an operation location, and an angle and a direction of each component during operation of the device;
the failure warning data comprises at least a failure warning serial number, a failure type, and a failure reason;
the test data comprises test data of device processing, generating, operating, and testing processes.

3. The electronic device of claim 1, wherein the processor is further configured to:
detect in real time whether a predetermined condition of inputting the device information is activated; and
input the device information of each of the plurality of devices when the predetermined condition of inputting the device information is activated.

4. The electronic device of claim 3, wherein:
the processor responds to the device information of each of the plurality of devices being input by an input device; and
the predetermined condition is new device information being input to the electronic device.

5. The electronic device of claim 4, wherein:
the serial number of each of the plurality of devices comprises a country code of manufacture, a field of use, a device function, a manufacturer, and a manufacturer serial number;
the country code of manufacture, the field of use, and device function, the manufacturer, and the manufacturer serial number are input to the electronic device manually through the input device.

6. A method of digitalizing device information implemented in an electronic device, the method comprising:
inputting device information of a plurality of devices to the electronic device, the device information comprising at least component information, control process information, operation data, failure warning data, and test data;
assigning a serial number to each of the plurality of devices and storing the serial number and the device information of each of the plurality of devices; and
sending the serial number and the device information of each of the plurality of devices to a server.

7. The method of claim 6, wherein:
the component information comprises at least a model number, a manufacturer, a manufacture date, an installation date, a size, a material, a function, an installation location, a control port, and a control command;
the control process information comprises at least control steps of the device, control commands of control nodes, control parameters, a logic relationship between control parameters, and a logic relationship between the control commands;
the operation data comprises at least a temperature, a humidity, an operation current, an operation voltage, an operation speed of each operation, an acceleration, an operation height, an operation location, and an angle and a direction of each component during operation of the device;
the failure warning data comprises at least a failure warning serial number, a failure type, and a failure reason;
the test data comprises test data of device processing, generating, operating, and testing processes.

8. The method of claim 6, wherein the processor is further configured to:
detect in real time whether a predetermined condition of inputting the device information is activated; and
input the device information of each of the plurality of devices when the predetermined condition of inputting the device information is activated.

9. The method of claim 8, wherein:
the processor responds to the device information of each of the plurality of devices being input by an input device; and
the predetermined condition is new device information being input by an input device to the electronic device.

10. The method of claim 9, wherein:
the serial number of each of the plurality of devices comprises a country code of manufacture, a field of use, a device function, a manufacturer, and a manufacturer serial number;
the country code of manufacture, the field of use, and device function, the manufacturer, and the manufacturer serial number are input to the electronic device manually through the input device.

11. A non-transitory storage medium having stored thereon instructions that, when executed by at least one processor of an electronic device, causes the at least one processor to execute instructions of a method for digitalizing device information, the method comprising:
inputting device information of a plurality of devices to the electronic device, the device information comprising at least component information, control process information, operation data, failure warning data, and test data;
assigning a serial number to each of the plurality of devices and storing the serial number and the device information of each of the plurality of devices; and
sending the serial number and the device information of each of the plurality of devices to a server.

12. The non-transitory storage medium of claim 11, wherein:
the component information comprises at least a model number, a manufacturer, a manufacture date, an installation date, a size, a material, a function, an installation location, a control port, and a control command;
the control process information comprises at least control steps of the device, control commands of control nodes, control parameters, a logic relationship between control parameters, and a logic relationship between the control commands;
the operation data comprises at least a temperature, a humidity, an operation current, an operation voltage, an operation speed of each operation, an acceleration, an operation height, an operation location, and an angle and a direction of each component during operation of the device;
the failure warning data comprises at least a failure warning serial number, a failure type, and a failure reason;
the test data comprises test data of device processing, generating, operating, and testing processes.

13. The non-transitory storage medium of claim 11, wherein the method further comprises:
detecting in real time whether a predetermined condition of inputting the device information is activated; and
inputting the device information of each of the plurality of devices when the predetermined condition of inputting the device information is activated.

14. The non-transitory storage medium of claim 13, wherein:
the processor responds to the device information of each of the plurality of devices being input by an input device; and
the predetermined condition is new device information being input to the electronic device.

15. The non-transitory storage medium of claim 14, wherein:
the serial number of each of the plurality of devices comprises a country code of manufacture, a field of use, a device function, a manufacturer, and a manufacturer serial number;
the country code of manufacture, the field of use, and device function, the manufacturer, and the manufacturer serial number are input to the electronic device manually through the input device.
